(19) United States
(12) Patent Application Publication
(10) Pub. No.: US 2009/0098002 A1
(43) Pub. Date: Apr. 16, 2009

(54) PROCESS FOR HARDFACING A METAL BODY

(75) Inventor: James COULAS, Calgary (CA)

Correspondence Address: EATON PEABODY PATENT GROUP, LLC, P.O. BOX 5249, 77 Sewall Street, Suite 3000, AUGUSTA, ME, 04332-5249, US

(73) Assignee: KUDU INDUSTRIES INC., Calgary (CA)

(21) Appl. No.: 12/323,039

(22) Filed: Nov. 25, 2008

Related U.S. Application Data
(63) Continuation-in-part of application No. 11/858,388, filed on Sep. 20, 2007, now abandoned.
Application No. 11/858,388 is a continuation-in-part of application No. 11/533,735, filed on Sep. 20, 2006, now abandoned.
(60) Provisional application No. 60/826,369, filed on Sep. 20, 2006.
(60) Provisional application No. 60/718,329, filed on Sep. 20, 2005.

(51) Int. Cl. F01C 21/08; B05D 1/08; C23C 4/10; C23C 4/06

(52) U.S. Cl. 418/178; 427/446; 427/456; 427/455; 427/450; 418/179

(57) ABSTRACT

A method of hardfacing a metal body, including the steps of flame spraying a metallic material onto a surface of the metal body to produce a layer of the metallic material on the metal body and fusing the layer of metallic material to provide a hardfacing layer, is improved by roughening the surface of the metal body prior to the step of flame spraying to provide a mechanical bond between the metal body and the hardfacing layer. The roughening is carried out to achieve a surface roughness adjusted to the thickness of the hardcoating. The surface roughness is preferably 40%-90% of the thickness of the hardfacing layer. A rotor for a progressing cavity pump/motor, including a metallic rotor body having a surface, and a layer of hardfacing on the surface, the hardfacing comprising of fused flame sprayed metallic material, the surface of the rotor body having an average surface roughness of at least substantially 6 mils with irregular protrusions for providing a mechanical bond between the rotor body and the hardfacing.

### CROSS-REFERENCE TO RELATED APPLICATIONS

This application is a Continuation-in-Part of U.S. patent application Ser. No. 11/533,735, entitled Process for Hardfacing a Progressing Cavity Pump/Motor Rotor, which claims priority from U.S. Provisional Patent Application Ser. No. 60/718,329, entitled Process for Hardfacing a Progressing Cavity Pump/Motor Rotor, and is also a Continuation-in-Part of U.S. application Ser. No. 11/858,388, entitled Process for Hardfacing a Progressing Cavity Pump/Motor Rotor, which claims priority from U.S. Provisional Patent Application Ser. No. 60/826,369, entitled Process for Hardfacing a Progressing Cavity Pump/Motor Rotor, wherein the contents of all of which are incorporated herein in their entirety.

### FIELD OF THE INVENTION

The present invention relates generally to wear-resistant hardfacings for movable parts. More particularly, the present invention relates to hardfacings for rotors of progressing cavity pumps/motors.

### BACKGROUND OF THE INVENTION

Progressing cavity pumps have been used in water wells for many years. More recently, such pumps have been found to be well suited for the pumping of viscous or thick fluids such as crude oil laden with sand. Progressing cavity pumps include a stator which is attached to a production tubing and a rotor which is attached to the bottom end of a pump drive string and is made of metallic material, usually high strength steel.

Progressing cavity motors are used to provide rotary power sections for use in horizontal and directional drilling. Progressing cavity motors include a stator which is connected with a drillpipe and a rotor which is attached to a drill bit. Drilling fluid is forced down the drillpipe causing rotation of the rotor and operation of the motor to rotate the drill bit.

The rotor is usually electroplated with chrome to resist abrasion. However, the corrosive and abrasive properties of the fluids produced in oil wells or utilized for drilling fluid frequently cause increased wear and premature failure of the rotor. Since it is important for efficient operation of the pump/motor that a high pressure differential be maintained across the rotor, only small variations in the rotor's dimensions are tolerable. This means that excessively worn rotors must be replaced immediately. However, replacement of the rotor requires pulling the whole pump/motor drive string from the well which is costly, especially in the deep oil well applications which are common for progressing cavity pumps/motors. Consequently, rotors with increased wear resistance and, thus, a longer service life are desired to decrease well drilling and operating costs.

Various hardfacing methods have been used in the past to increase the wear resistance of metal surfaces.

A number of progressing cavity pump/motor manufacturers chrome electroplate the rotors to increase wear resistance. Chrome electroplating does provide increased wear resistance, but is susceptible to corrosion in the harsh environment of downhole production and drilling.

Another way of increasing wear resistance is to deposit a coating or layer of material onto the rotor by thermal spraying. Conventional flame spraying uses a relatively low flame temperature and particle velocity (such as less than about 40 m/s), and results in coatings with high porosity and permeability as well as low bond strength. Nevertheless, it allows the spraying of a layer with much smaller thickness variations, overcoming the problem of uncontrollable thickness variations experienced with other thermal spraying techniques.

U.S. Pat. No. 3,310,423 to Ingham makes reference to conventional flame spraying usually requiring severe mechanical roughening for example by sand or grit blasting or machine roughening which forms key-like cavities, and that a light sand-blasting is insufficient. Ingham also makes reference to fusing after flame spraying to increase the density and bond.

U.S. Pat. No. 4,004,042 to Fairbairn teaches a method for coating with a mixture of tungsten carbide powder and nickel chrome boron powder. The surface is cleaned by grit blasting using aluminum oxide particles, for example. Then the coating is applied by a “stream of energy” such as provided by a plasma generating gun, covered with a protective film (using boric acid or boric oxide) and fused at elevated temperature.

U.S. Pat. No. 4,013,453 to Patel teaches flame spraying a powder containing WC to obtain a wear resistant coating, including the step of fusing the coating after deposition by bringing a torch tip within about 1″ of the coating until the coating melts and bonds metallurgically to the substrate.

U.S. Pat. No. 4,161,555 to Appleman teaches a flame spraying process for materials requiring fusion, in which a particular method of fusing is taught using a removable siliceous film.

U.S. Pat. No. 4,241,110 to Ueda et al. teaches a rotor blade having a coating of at least one coat each of Ni—Cr—B—Si alloy and WC applied by spraying and fusing. The surface to be treated is cleaned by grid blasting or the like. Then, powders of a Ni—Cr—B—Si alloy and WC are fed in succession into and melted or heated by a flame, e.g. an oxyacetylene flame. For greater joining strength, the coats formed by spraying are heated, e.g. by an oxyacetylene flame up to the melting point of the alloy to fuse the particles solidly onto the surface.

U.S. Pat. No. 4,517,726 to Yokoshima et al. teaches shot blasting to clean the surface to be coated, followed by plasma spraying in a method of producing a seal ring.

U.S. Pat. No. 5,455,078 to Kanzaki teaches a method of coating an aluminum or aluminum alloy valve lifter with iron, including the steps of primary blasting to form a rough surface having larger irregularities (using preferably grit), secondary blasting to form smaller irregularities, and forming a coating layer of wear resistant material on the surface (preferably by thermal spraying) thereby increasing the adhesion strength of the coated layer.

U.S. Pat. No. 5,395,221 to Tucker et al. teaches a progressive cavity pump/motor rotor with a coating of metal carbide with a metal alloy using thermal spray processes which include detonation gun deposition, oxy-fuel flame spraying, high velocity oxy-fuel deposition, and plasma spray, and also teaches that the coating particle size must be less than the size of the particles in the fluid or the fluid particles will abrade and wear off the coating particles. Tucker et al. teaches the use of a sealant to address the porosity challenge.

U.S. Pat. No. 6,425,745 to Lavin teaches a surface treatment for helically profiled rotors, such as progressing cavity pump/motor rotors by high velocity oxygen fuel (HVOF) spraying of a WC/ceramic composite coating onto the surface of a rotor by traversing the axis of the rotor while the rotor is rotated in synchronism to maintain the proper position of the spray relative to the surface of the rotor, to give a desired coating thickness profile.

In general, conventional flame spraying techniques result in coatings with high porosity and permeability as well as low bond strength, although they do allow the spraying of a layer of sufficiently consistent thickness. Thickness variations on the other hand are a major problem with other coating techniques, such as high velocity oxygen fuel (HVOF) or detonation gun (D-gun) coating. Furthermore, those coating techniques cannot always be used to produce a sufficiently thick coating. In order to prevent failure of the coating during use, the thickness of the coating must be equal to at least 50% of the diameter of any particles to which the coating is exposed during use. Moreover, sufficiently thick coatings, even if achievable are subject to pitting and spalling during use, due to insufficient bond strength with the underlying metal layer.

It is, therefore, desirable to provide a method for hardfacing a rotor for a progressing cavity pump/motor which overcomes the problems associated with conventional flame spraying and chrome coatings.

### SUMMARY OF THE INVENTION

It is an object of the present invention to obviate or mitigate at least one disadvantage of previous methods for hardfacing and of rotors for progressing cavity pumps/motors.

In conventional hardcoating processes using flame spraying, the coating is fused to reduce the high porosity and permeability of the sprayed-on layer. The underlying substrate may be roughened prior to flame spraying to provide increased bond strength. The result is a lower porosity, lower permeability coating with a stronger bond to the substrate. However, sprayed-on and fused coatings are still subject to pitting and spalling upon flexing and impact, even when the surface to be coated is roughened prior to application of the hardcoating.

It has now been surprisingly found by the applicant that the bond strength of the coating with the underlying substrate can be significantly increased and pitting and spalling substantially prevented, even on impact and flexing, if the surface is not only roughened prior to hardcoating, but if the surface roughness is coordinated with the coating thickness. In particular, superior bond strength is achieved when the substrate is roughened prior to spray coating by grit blasting, preferably metal grit blasting, to achieve a surface roughness, the depth of which is adjusted to at least 40% of the intended coating thickness. The result is a sufficiently deep inter-penetration of the coating and the substrate to achieve a superior bond strength, even for relatively thick coatings. The inter-penetration of the substrate and the coating to such a large degree also results in a bond strength of the coating which is substantially equal to the strength of the substrate. The maximum surface roughness is preferably 90% of the coating thickness, to avoid exposure of the substrate upon polishing of the coating or premature exposure of the substrate during use. For example, for a coating of 10 mil thickness, the surface roughness should be at least 4 mil and at most 9 mil.

The concept of surface roughness or rugosity is well understood by the art skilled person and is a measurement of the small-scale irregularities in a physical surface. The term “surface roughness” generally refers to the depth of a surface profile or texture measured as the peak to valley height of individual surface features in the surface profile or texture.

Coatings providing the desired wear resistance and improved corrosion resistance are selected to increase service life.

In a first aspect, the present invention provides a method of hardfacing a metal body, with the steps of flame spraying a metallic coating material onto a surface of the metal body to produce a metallic coating having a coating thickness and fusing the metallic coating to provide a hardfacing layer, and the additional step of roughening the surface of the metal body prior to the flame spraying step for generating a surface roughness of at least 40% and at most 90% of the coating thickness.

In a second aspect, the invention provides a method of hardfacing a metal body with a coating layer having an intended coating thickness, comprising the steps of roughening a surface of the metal body to a surface roughness, the depth of which equals at least 40% and at most 90% of the intended coating thickness, flame spraying a metallic coating material onto the roughened surface of the metal body until the intended coating thickness is achieved and fusing the layer of metallic material to provide a hardfacing layer.

In a third aspect, the invention provides a rotor for a progressing cavity pump/motor, comprising a metallic rotor body having a surface, and a layer of hardfacing on the surface, the hardfacing consisting of flame sprayed and fused metallic material applied at a coating thickness, the surface of the rotor body having a surface roughness with irregular protrusions for providing a mechanical bond between the rotor body and the hardfacing, the surface roughness of the irregular protrusions being equal to 40-90% of the coating thickness.

Preferably, the surface roughness is between 50% and 90%, more preferably between 60% and 90%, most preferably between 70% and 90% of the intended coating thickness.

Preferably, the step of roughening the surface of the metal body is achieved by grit blasting. The grit is preferably metal grit selected to have a hardness at least equal to that of the metal body. The grit hardness is preferably between about 20 and 50 Rockwell. The step of grit blasting preferably is carried out at an air pressure between about 80 and 150 psi. The surface roughness is preferably at least 6 mil, more preferably at least 8 mil.

Metal grit used for surface roughening is normally discarded after use, since it breaks down upon use. However, it has also been surprisingly discovered that the step of roughening the surface of the metal body can be rendered more effective when the metal grit used for grit blasting includes both previously used, recycled grit and fresh, unused grit. This is contrary to what would be expected, since recycled grit is partly broken down and would be expected to be less effective in roughening the surface. In a preferred embodiment, the grit material used is an admixture of a major amount of recycled grit and a minor amount of fresh grit. Fresh grit can be added at regular intervals, or continuously, but the amount of fresh grit is preferably less than 40% of the total grit used, more preferably 30%, most preferably about 25%.

Recycling used grit, although advantageous from a coating effectiveness standpoint, has been found to cause contamination problems. The inventors have however discovered that washing the recycled grit in a caustic bath, preferably caustic soda, will overcome the contamination problem.

The step of roughening the surface of the metal body preferably creates a multiplicity of jagged irregular projections and indentations, substantially covering the surface of the metal body.

Preferably, the hardfacing method includes additional steps prior to the step of flame spraying the metallic material onto the metal body, namely, the steps of predicting the approximate expected grain size of an abrading substance, to be encountered by the metal body when the metal body is placed into service, and selecting a grain size for the metal carbide powder that is finer than the expected grain size of the abrading substance.

The layer of metallic material is preferably fused by inductive heating to produce the hardfacing layer. The layer of metallic material is preferably applied at a thickness of at least 9 mil and is preferably applied at a substantially uniform thickness. The metallic material is preferably selected from the group consisting of chromium, molybdenum and nickel and alloys thereof. Most preferably, the metallic material includes a NiCr alloy. The metallic material preferably includes between about 30 wt. % and 80 wt. % metal carbide powder. The metal carbide powder is preferably selected from the group consisting of the carbides of tungsten, titanium, tantalum, columbium, vanadium and molybdenum. Most preferably, the metal carbide powder includes tungsten carbide.

In a further aspect, the present invention provides a downhole progressing cavity pump/motor, including a pump rotor in accordance with the invention and a pump stator.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Embodiments of the present invention will now be described, by way of example only, with reference to the attached drawings, wherein:

FIG. 1 shows the principal components of a progressing cavity pump/motor;

FIG. 2 schematically illustrates a roughened surface of the progressing cavity pump/motor; and

FIG. 3 schematically illustrates a hardfacing layer applied to the progressing cavity pump/motor.

### DETAILED DESCRIPTION

The present invention in general is directed to a method of hardfacing a metal body which includes the steps of flame spraying a metallic coating material onto a surface of the metal body to produce a metallic coating having a coating thickness and fusing the metallic coating to provide a hardfacing layer, wherein the method also includes the step of roughening the surface of the metal body prior to the flame spraying step for generating a surface roughness, the depth of which is at least 40% and at most 90% of the coating thickness.

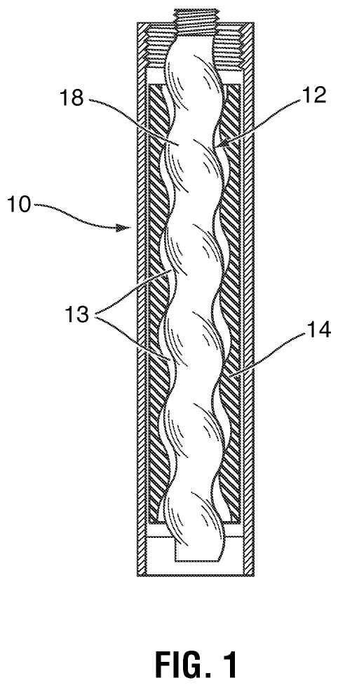

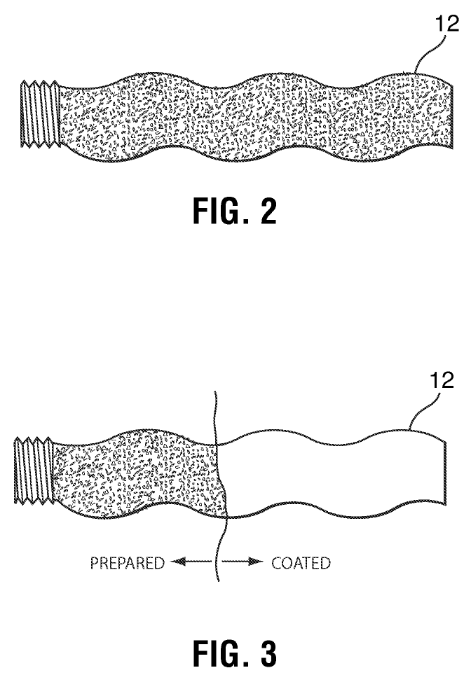

In the preferred embodiment, the hardfacing in accordance with the present invention is applied to the rotor of a progressing cavity pump/motor 10 as shown in FIG. 1 by roughening the surface of the rotor body, flame spraying a metallic coating material onto the roughened surface to achieve a metallic coating of a selected coating fluidness, and fusing the metallic coating. In the roughening step, the surface of the rotor body is roughened for generating a surface rougheness of at least 40% of the thickness of the metallic coating to be subsequently applied.

Progressing cavity pumps/motors include a helical rotor 12 made of ferrous metal, usually high strength steel, and a stator having a generally double helical rotor receiving bore 15 of twice the pitch length. The dimensions of the rotor and stator are coordinated such that the rotor tightly fits into the bore 15 and a number of individual pockets or cavities 13 are formed which are inwardly defined by the rotor 12 and outwardly by the stator 14. Upon rotation of the rotor 12 in the operating direction, the cavities 13 and their contents are pushed spirally about the axis of the stator 14 to the output end of the pump. The seal between the cavities is made possible by an interference fit between the rotor and the elastomeric material of the stator 14. The rotor 12 and stator 14 are at all times in tight contact in the areas between the cavities which results in the wear of both components and in particular the rotor, especially when sand-laden and corrosive liquids are pumped as is often the case in deep oil well applications.

In the preferred embodiment, the surface of the rotor 12 is mechanically roughened by grit blasting to provide increased bond strength. The grit blasting involves impinging the rotor 12 with steel grit formed of angular particles, delivered upon the surface of the rotor 12 through the use of pneumatics (such as through the use of air or an inert or other substance), or other methods known to those skilled in the art of surface blasting.

The grit is selected to have a hardness greater than or equal to the hardness of the rotor 12. The grit blasting forms a multiplicity of jagged or irregular projections and indentations, substantially covering the surface of the rotor body. The roughness of the grit blasted surface is adjusted to be at least 40% of the intended thickness of the metallic coating. To achieve superior bond strength, the grit blasting is preferably carried out under conditions which will generate a surface roughness of 40-90% of the intended coating thickness, preferably 60-90% and most preferably 70-90%. Although surface roughening by shot blasting is known as well, such roughening is not preferred for the present invention. Shot blasting produces rounded indentations. As a result, the mechanical connection between the metallic coating and the rotor may not be sufficient to guarantee a long service life for the rotor. Grit blasting produces jagged and irregular projections and indentations in the rotor body surface. Thus, roughening by grit blasting produces superior bonding strength between the rotor and the metallic coating due to the mechanical interlocking connection between the metallic coating and the rotor body.

After the surface of the rotor 12 is roughened, it may be cleaned to remove any grit blasting residue, for example by pneumatic cleaning.

A metallic material layer is flame-sprayed onto the roughened surface of the rotor, or onto a bond coating on the rotor, by way of a flame spray gun. Flame spray coating processes and apparatus are well known in the art. In brief, the flame spray process uses a chemical combustion reaction (flame) from oxygen and a fuel (such as acetylene or hydrogen) to produce a heat source which creates a gas stream. The coating material to be flame sprayed is fed into the flame in the form of a wire or a powder. The powder is heated by the flame to a molten or plastic condition and projected onto the base metal part to be coated by a compressed gas (such as air). Upon impact, a bond is formed at the interface between the molten or plastic powder and the base metal part.

The metallic material may be chromium (Cr), molybdenum, nickel (Ni) or alloys thereof. In the preferred embodiment, the metallic material is a NiCr alloy. The metallic material may be applied in a single layer, or may be applied in a plurality of layers to form a coating of the metallic material on the rotor body. The average thickness of the layer of metallic material can be about 9 mils to about 100 mils. This can be accomplished in a single layer or single pass. Flame spraying generally provides a substantially uniform coating thickness.

The metallic material may further include between about 30 wt. % and 80 wt. % metal carbide powder. The metal carbide may be carbides of tungsten, titanium, tantalum, columbium, vanadium, and molybdenum. In the preferred embodiment, the metal carbide is tungsten carbide (WC).

As an example, a typical progressing cavity pump/motor rotor may be hardfaced in accordance with the present invention, as follows. First, the surface is roughened by grit blasting with grit having a hardness of 30 Rockwell, using an air pressure of 130 psi. Then, a layer of NiCr with 40% WC is applied using flame spraying.

In contrast with a plasma gun type thermal spray, the flame spraying of the present invention provides that the WC is not plasticized as it would be with plasma spray, but instead is cemented in place on the rotor body by the metallic material (e.g. NiCr). In a typical downhole application, there is some expectation or prediction of what abrading substances may be encountered, for example sand is a well known and expected abrading substance. Typically, the metal carbide powder (e.g. WC) is selected to have a finer grain size than that of the expected abrading substance, so that the hardness of the metal carbide will resist abrasion by the abrading material. If the abrading substance is finer than the metal carbide, the metallic material (e.g. NiCr) will be abraded and the metal carbide will delaminate or fall off.

After application, the surface of the metallic material is fused to reduce porosity and permeability of the coating. Fusing involves bringing the surface of the metallic material almost to, but just short of, its melting point. Typically this is done through electric induction heating. However, those skilled in the art recognize there are many ways to fuse the bond, and are skilled in the recognition of the appropriate temperature. Typically fusing is done manually with visual recognition of the appropriate level or degree of fusion.

### EXAMPLE I

For an intended metallic coating thickness of 9 mils, the surface of a progressing cavity pump was roughened by grit blasting and subsequently hardfaced by flame spraying a WC containing metallic material onto the roughened surface. Typically, only that portion of the rotor surface which comes into contact with the fluids to be pumped is roughened and provided with a hardfacing layer. The grit used was steel grit with a hardness of 30 Rockwell and was blown at the rotor using an air pressure of 85 psi. The steel grit was stored in a hopper for feed into the pressurized air stream. Used grit was recycled into the hopper. Each time the grit level in the hopper decreased to less than 75% of the full level, fresh grit was added until a load of 90-100% was reached. The recycled grit was passed through a caustic soda bath before returning it to the hopper, in order to avoid contamination of the workpiece surface to be roughened and coated.

### EXAMPLE II

A metallic coating thickness of 15 mils applied and all other conditions were identical to those described in Example I.

### EXAMPLE III

A metallic coating of 15 to 20 mils was applied to a surface which was roughened by grit blasting to a surface roughness of 10 to 12 mils. The grit had a hardness of 40 Rockwell and was blown at the rotor using an air pressure of 95 psi.

### EXAMPLE IV

A metallic coating of 25 mils was applied to a rotor surface roughened by grit blasting with grit of about 50 Rockwell and at an air pressure of 105 psi to achieve a surface roughness of 14 mils. Thicker coatings can be equally applied to a surface having a surface roughness of 14 mils.

Although the hardfacing method and progressing cavity pump/motor rotor of the present invention was described in detail only for the application of a metallic material such as an alloy of NiCr, a person skilled in the art will readily appreciate that other metallic materials can be used such as chrome, molybdenum and nickel, especially chrome/molybdenum and nickel/chromium alloys. Similarly, although described in detail only for the application of a metal carbide, such as WC, a person skilled in the art will readily appreciate that other metal carbides can be used, such as the carbides of tungsten, tantalum, titanium, columbium, vanadium and molybdenum. Furthermore, any conventional fusing process adapted to fuse the coating material and the rotor can be used for the application of the top layer.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. In a method of producing a hardfacing for exposure to an abrasive working environment on a metal body, including the steps of flame spraying one or more layers of a metallic coating material onto a surface of the metal body to produce a metallic coating having a total coating thickness and fusing the metallic coating to provide a fused hardfacing layer for exposure to the abrasive working environment, the improvement comprising the step of roughening the surface of the metal body prior to the flame spraying for generating a surface roughness equal to at least 40% and at most 90% of the total coating thickness.

2. The method of claim 1, wherein the step of roughening the surface of the metal body comprises the step of forming a multiplicity of jagged irregular projections and indentations, substantially covering the surface of the metal body.

3. The method of claim 1, wherein the step of roughening the surface of the metal body comprises grit blasting.

4. The method of claim 3, wherein the blasting comprises blasting with an admixture of previously used, recycled metal grit and fresh, unused metal grit.

5. The method of claim 4, wherein the grit blasting comprises blasting with steel grit having a hardness at least equal to a hardness of the metal body and the admixture includes a major amount of recycled grit and a minor amount of fresh grit.

6. The method of claim 5, wherein the grit blasting comprises blasting with steel grit having a hardness between about 20 and about 50 Rockwell.

7. The method of claim 3, wherein the grit blasting comprises blasting with grit at an air pressure of between about 80 psi and about 150 psi.

8. The method of claim 1, wherein the minimum surface roughness is 8 mil.

9. The method of claim 1, wherein the metallic material is selected from the group consisting of chromium, molybdenum and nickel and alloys thereof.

10. The method of claim 8, wherein the thickness of the layer of metallic material is substantially uniform.

11. The method of claim 1, wherein the metallic material comprises between about 30 wt. % and 80 wt. % metal carbide powder.

12. The method of claim 11, wherein the metal carbide powder is selected from the group consisting of the carbides of tungsten, titanium, tantalum, columbium, vanadium and molybdenum.

13. The method of claim 12, further comprising, prior to the step of flame spraying the metallic material onto the metal body, the steps of:
(a) predicting the approximate expected grain size of an abrading substance to be encountered by the metal body when the metal body is placed into service; and
(b) selecting a grain size for the metal carbide powder that is finer than the grain size of the abrading substance.

14. The method of claim 1, wherein the step of fusing the layer of hardfacing comprises heating by inductive heating.

15. The method of claim 1, wherein the metal body is a rotor for a progressing cavity pump/motor.

16. A rotor for a progressing cavity pump/motor, comprising:
(a) a metallic rotor body having a surface; and
(b) a layer of hardfacing on the surface, the hardfacing consisting of flame sprayed and fused metallic material applied at a coating thickness, the surface of the rotor body having a surface roughness with irregular protrusions for providing a mechanical bond between the rotor body and the hardfacing, the surface roughness having a depth equal to 40-90% of the coating thickness.

17. The rotor of claim 16, wherein the flame sprayed metallic material is selected from the group consisting of chromium, molybdenum and nickel and alloys thereof.

18. The rotor of claim 16, wherein the irregular protrusions are formed by a multiplicity of jagged irregular projections and indentations in the surface of the rotor body.

19. The rotor of claim 16, wherein the surface of the metal body has a surface roughness of 60-90% of the coating thickness.

20. The rotor of claim 16, wherein the surface of the metal body has a surface roughness of 70-90% of the coating thickness.
